(19) United States
(12) Patent Application Publication
(10) Pub. No.: US 2026/0245113 A1
(43) Pub. Date: Aug. 20, 2026

(54) TERMINAL, METHOD, AND PROGRAM

(71) Applicant: NIPPON TELEGRAPH AND TELEPHONE CORPORATION, Tokyo (JP)

(72) Inventors: Naoto KIRIBUCHI, Tokyo (JP); Iifan TYOU, Tokyo (JP); Nami ASHIZAWA, Tokyo (JP); Ryohei SUZUKI, Tokyo (JP)

(73) Assignee: NIPPON TELEGRAPH AND TELEPHONE CORPORATION, Tokyo (JP)

(21) Appl. No.: 18/869,943

(22) PCT Filed: May 30, 2022
(86) PCT No.: PCT/JP2022/021990

§ 371 Date: Nov. 27, 2024

(51) Int. Cl. G06Q 30/0601; G06Q 30/0207

(52) U.S. Cl. CPC G06Q 30/0217; G06Q 30/0282; G06Q 30/0609

(57) ABSTRACT

A terminal according to an aspect of the present disclosure is a terminal to be used by each of a plurality of participants participating in a predetermined platform and includes a secure calculation unit that executes predetermined incentive processing according to content of an evaluation x by secure multi-party computation with another terminal connected via a communication network using a fragment [x] of the evaluation x for an evaluation target.

### TECHNICAL FIELD

The present disclosure relates to a terminal, a method, and a program.

### BACKGROUND ART

Although transactions on the Internet including transactions between individuals are becoming widespread, it is difficult to trust a transaction partner or a transaction target that cannot be directly viewed only by words of the partner. For this reason, evaluations (reviews) of the transaction partner or the transaction target from other persons are widely used as a material for determining whether or not to perform a transaction. Although the number and quality are important to use reviews as a material for determining a transaction, in order to achieve a situation where honest reviews are positively written, there is a problem in terms of incentive for reviewers and information confidentiality (for example, concealment of reviewers, content of reviews, and the like) regarding reviews. In other words, it takes time and effort to write a review, and thus, there is a problem that a reasonable person does not write a review unless there is a direct benefit (incentive). In addition, if information regarding the review is not concealed, there is a problem that an honest review may not be written due to a risk of reprisal by writing a negative review, apologies, or the like.

Among the above two problems, as a method for solving the problem of an incentive for reviewers in related art, there is a method of granting an incentive such as virtual currency or a discount ticket to reviewers. In addition, as a method for solving the problem of information confidentiality regarding reviews in related art, there is a method of anonymizing reviewers by a mix net or a ring signature. Furthermore, as a method for solving the problems of two aspects of incentive for reviewers and information confidentiality regarding reviews in related art, there is a method disclosed in Non Patent Literature 1. In the method disclosed in Non Patent Literature 1, a discount ticket is given to a participant who gives an evaluation value to a transaction partner, and when evaluation values of other participants are referred to, only total values of individual evaluation values are disclosed while keeping the individual evaluation values concealed by secure multi-party computation (SMP). Note that the secure multi-party computation is also simply referred to as multi-party computation (MPC).

### CITATION LIST

### Non Patent Literature

Non Patent Literature 1: Yanbin, Liu, et al. “A Secure Reputation System Based SMC.” 2009 WRI International Conference on Communications and Mobile Computing. Vol. 3. IEEE, 2009.

### SUMMARY OF INVENTION

### Technical Problem

However, in the method disclosed in Non Patent Literature 1 described above, a discount ticket is given only by a fact that an evaluation value is assigned to a transaction partner, and thus, a flexible incentive according to content of an evaluation cannot be given.

The present disclosure has been made in view of the above points, and an object of the present disclosure is to provide a technology that implements flexible incentive processing according to content of an evaluation while keeping the evaluation on other people concealed.

### Solution to Problem

A terminal according to an aspect of the present disclosure is a terminal to be used by each of a plurality of participants participating in a predetermined platform and includes a secure calculation unit that executes predetermined incentive processing according to content of an evaluation x by secure multi-party computation with another terminal connected via a communication network using a fragment [x] of the evaluation x for an evaluation target.

### Advantageous Effects of Invention

There is provided a technology for implementing flexible incentive processing according to content of an evaluation while keeping the evaluation on other people concealed.

### BRIEF DESCRIPTION OF DRAWINGS

FIG. 1 is a view illustrating an example of an overall configuration of a secure incentive processing system according to the present embodiment.

FIG. 2 is a view illustrating an example of a hardware configuration of a participant terminal according to the present embodiment.

FIG. 3 is a view illustrating an example of a functional configuration of the participant terminal according to the present embodiment.

### DESCRIPTION OF EMBODIMENTS

Hereinafter, one embodiment of the present invention will be described. In the following embodiment, a secure incentive processing system 1 capable of performing flexible incentive processing according to content of a review while keeping the evaluation (review) on other participants concealed will be described. Here, a participant is a person (user) who participates in a platform on which products, services, or the like, can be traded. Each participant may trade products or services with other participants, evaluate (review) other participants or refer to the evaluations (reviews) of himself/herself or other participants. Typical examples of such a platform include a C to C type EC platform in which a so-called free market is implemented among participants, a normal B to C type EC platform, and the like. However, these are examples, and participants participating in any platform can be targeted as long as it is a platform on which products or services can be traded with other participants, and which allows reviewing on other participants and referring to the reviews of themselves or other participants.

In the secure incentive processing system 1 according to the present embodiment, the incentive processing (hereinafter, also referred to as secure incentive processing) according to content of a review is implemented while keeping the review on other participants concealed by multi-party computation (MPC) between the participants.

The MPC is a method in which n participants obtain f(x) while keeping an input x concealed. More specifically, the method is as follows. The fragment (share) below of x is distributed to participants, and

$$〚 x 〛 \qquad [ Math . 1 ]$$

each participant obtains the fragment below of f(x) through communication and calculation between the participants.

$$〚 f ( x ) 〛 \qquad [ Math . 2 ]$$

Then, a participant who desires to obtain f(x) can obtain f(x) by collecting the sufficient number of the fragments below.

$$〚 f ( x ) 〛 \qquad [ Math . 3 ]$$

Hereinafter, in the text of the present specification, a fragment of x or a fragment of f(x) will be expressed as [x] or [f(x)].

In this event, by setting a review to x and incentive processing for the review to f(x), processing can be performed while keeping content of the review and an incentive processing result concealed to other participants.

### <Overall Configuration Example of Secure Incentive Processing System 1>

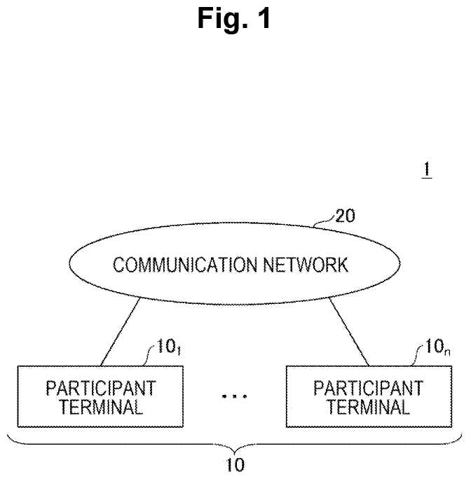

FIG. 1 illustrates an overall configuration example of the secure incentive processing system 1 according to the present embodiment. As illustrated in FIG. 1, the secure incentive processing system 1 according to the present embodiment includes a plurality of participant terminals 10. These participant terminals 10 are communicably connected via a communication network 20 including the Internet, and the like. Note that, in the example illustrated in FIG. 1, n participant terminals 10 of a participant terminal 10₁, . . . , and a participant terminal 10ₙ are included. n is the number of participants.

The participant terminal 10 is various kinds of terminals (for example, a personal computer (PC), a smartphone, a tablet terminal, a wearable device, a general-purpose server, or the like) to be used by the participant. The participant terminal 10 executes secure incentive processing with another participant terminal 10 by the MPC. Note that the participant terminal 10 may be referred to as, for example, a “secure incentive processing device”, or the like.

### <Hardware Configuration Example of Participant Terminal 10>

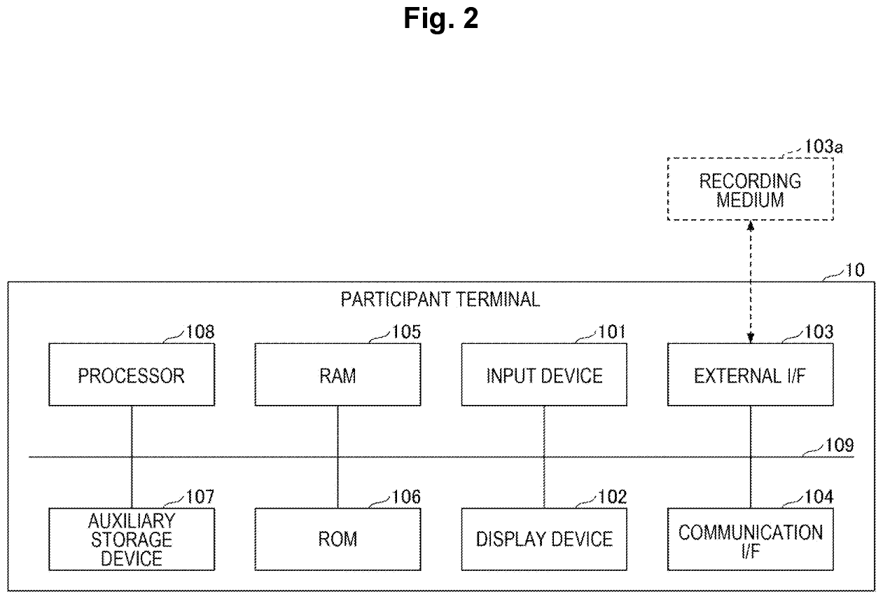

FIG. 2 illustrates a hardware configuration example of the participant terminal 10 according to the present embodiment. As illustrated in FIG. 2, the participant terminal 10 according to the present embodiment includes an input device 101, a display device 102, an external I/F 103, a communication I/F 104, a random access memory (RAM) 105, a read only memory (ROM) 106, an auxiliary storage device 107, and a processor 108. These pieces of hardware are communicatively connected via a bus 109.

The input device 101 is, for example, a keyboard, a mouse, a touch panel, a physical button, or the like. The display device 102 is, for example, a display, a display panel, or the like. Note that the participant terminal 10 does not have to include at least one of the input device 101 or the display device 102, for example.

The external I/F 103 is an interface with an external device such as a recording medium 103a. The participant terminal 10 can, for example, perform reading from and writing in the recording medium 103a via the external I/F 103. Examples of the recording medium 103a include a flexible disk, a compact disc (CD), a digital versatile disk (DVD), a secure digital memory card (SD memory card), a universal serial bus (USB) memory card, and the like.

The communication I/F 104 is an interface for connecting the participant terminal 10 to the communication network 20. The RAM 105 is a volatile semiconductor memory (storage device) that temporarily holds programs and data. The ROM 106 is a non-volatile semiconductor memory (storage device) capable of holding programs and data even when power is turned off. The auxiliary storage device 107 is, for example, a storage device such as a hard disk drive (HDD), a solid state drive (SSD), or a flash memory. The processor 108 is, for example, an arithmetic device such as a central processing unit (CPU).

The participant terminal 10 according to the present embodiment having the hardware configuration illustrated in FIG. 2 can implement various types of processing to be described later. Note that the hardware configuration illustrated in FIG. 2 is an example, and the hardware configuration of the participant terminal 10 is not limited thereto. For example, the participant terminal 10 may include a plurality of auxiliary storage devices 107 and a plurality of processors 108, does not have to include part of the illustrated hardware, or may include various kinds of hardware other than the illustrated hardware.

### <Functional Configuration Example of Participant Terminal 10>

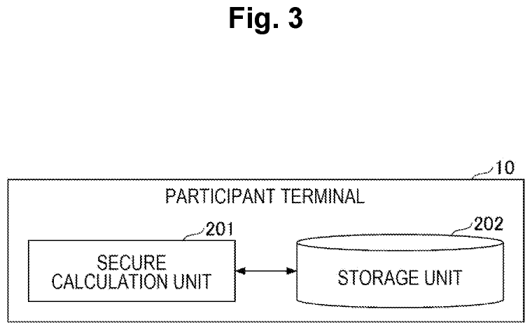

FIG. 3 illustrates a functional configuration example of the participant terminal 10 according to the present embodiment. As illustrated in FIG. 3, the participant terminal 10 according to the present embodiment includes a secure calculation unit 201 and a storage unit 202. The secure calculation unit 201 is implemented, for example, by processing to be executed by the processor 108 by one or more programs installed in the participant terminal 10. Furthermore, the storage unit 202 is implemented by, for example, a storage device such as the auxiliary storage device 107 or the RAM 105.

The secure calculation unit 201 executes secure incentive processing with another participant terminal 10 by the MPC. The storage unit 202 stores various kinds of information (for example, a fragment (share), and the like).

### EXAMPLES

Hereinafter, examples of the present embodiment will be described.

### Example 1

In a case where a value called reputation, or the like, is set for a participant, a product, a service, or the like, and a review is written, the reputation of the participant who has written the review and the reputation of an evaluation target (such as another participant, product and service) evaluated by the review may fluctuate. Thus, in Example 1, secure incentive processing for such incentive processing such as reflection in reputation will be described.

The review is set as x. As the review x, for example, a numerical value such as the number of stars is assumed. In addition, the reputation of the participant who has written the review (reviewer) is set as rt, and the reputation of the evaluation target is set as rs. In this event, the secure calculation unit 201 of each participant terminal 10 executes the following update formula by the MPC.
[rₜ′]←f([rₜ], [x])
[rₛ′]←([rₛ], [x])

Here, rₜ′ is the updated reputation of the reviewer, and rₛ′ is the updated reputation of the evaluation target. f is a function that outputs the updated reputation [rₜ′] of the reviewer according to the content of the review [x] and current reputation [rₜ] of the reviewer. g is a function that outputs the updated reputation [rₛ′] of the evaluation target according to the content of the review [x] and the current reputation [rₛ] of the evaluation target.

As a result, by appropriately designing the functions f and g, it is possible to update the reputation of the reviewer and the reputation of the evaluation target according to the content of the review while keeping the review x concealed.

### Example 2

Some information (for example, useful information, reviews by other participants, coupons, etc.) may be disclosed as an incentive for a participant having a good reputation (reputation). Thus, in Example 2, the secure incentive processing for the incentive processing such as control of an information disclosure range will be described.

It is assumed that information z is disclosed only in a case where a reputation value r_{q} of a participant P_{q} is equal to or greater than a predetermined value a.

h(r_{q}, a) is a function that returns 1 in a case where r_{q} is equal to or greater than a, and otherwise, returns 0. In this event, the secure calculation unit 201 of each participant terminal 10 obtains [z×h(r_{q}, a)] by the MPC. Then, the secure calculation unit 201 of the participant terminal 10 of the participant P_{q} restores z x h(r_{q}, a). As a result, if z×h(r_{q}, a)=0, the information z is not disclosed, and otherwise, the information z is obtained.

Note that, in a case where 0 is included in the information z, the value may be shifted by addition, and the value may be restored from shifting after the information z is obtained.

### Example 3

Discount points may be granted to participants who have written reviews. The discount point is, for example, a point that can be used for a discount at the time of purchase of a product or a service (although, other than this, for example, the discount point may be used to be exchanged to a premium). Thus, in Example 3, the secure incentive processing for the incentive processing such as granting of the discount point will be described.

The discount point di granted to each participant Pᵢ (where i is the participant ID identifying the participant) is shared among the participants. However, in this event, the discount point dᵢ is concealed. In other words, it is assumed that {(Pᵢ, [dᵢ])|i=1, . . . , n} is stored in the storage unit 202 of the participant terminal 10 of each participant Pᵢ.

In a case where a discount point is granted to the participant Pᵢ in accordance with the content of the review [x] or the reputation [rᵢ], the current discount point is updated by the function f that calculates the granted discount point. In other words, the secure calculation unit 201 of each participant terminal 10 updates the discount point to (Pᵢ, [dᵢ′]←f([dᵢ], [x], [rᵢ])) by the MPC. Here, dᵢ′ is the updated discount point of the participant Pᵢ. As a result, by appropriately designing the function f, the discount point can be granted according to the content of the review and the reputation of the participant to whom the discount point is to be granted while keeping the review x concealed.

In addition, in a case where a discount point is used at the time of transaction, or the like, the discount point is updated after it is verified that a usage point amount a is equal to or less than [dᵢ]. In other words, h([dᵢ], a) is a function that returns 1 when dᵢ is equal to or greater than a, and otherwise, returns 0. In this event, the secure calculation unit 201 of each participant terminal 10 calculates and restores h([dᵢ], a) by the MPC and updates the result to (Pᵢ, [dᵢ′]←[dᵢ]−a) by the MPC if the result is 1.

### Example 4

In a case where a participant desires to conduct a transaction with another participant, whether or not to actually conduct the transaction may be controlled in accordance with the reputation of the other participant. For example, in a case where the reputation of the other participant is low, the transaction is not performed. On the other hand, in a case where the reputation is concealed, such control cannot be performed. Thus, in Example 4, the secure incentive processing for the incentive processing such as control of a transaction will be described.

The participants who are to conduct a transaction are set as Pa and Pb, a reputation of the participant Pa is set as [rₐ], and a reputation of the participant Pb is set as [r_{b}]. In this event, the secure calculation unit 201 of each participant terminal 10 calculates C ([rₐ], [r_{b}]) by the MPC. Here, C is a function that outputs some kind of index value for determining whether or not to conduct a transaction according to the reputations [rₐ] and [r_{b}]. With an output of the function C, at least one of the participants Pₐ and P_{b} can determine whether or not to conduct a transaction with the other participant and control whether or not to conduct the transaction.

### Example 5

The incentive processing described in Example 1 to Example 4 described above may be appropriately combined according to the design of the incentive. Thus, any two or more of Examples 1 to 4 may be combined as Example 5.

### CONCLUSION

As described above, in the secure incentive processing system 1 according to the present embodiment, by performing various calculations between participants by the MPC, it is possible to implement flexible incentive provision according to the content of the review in a state where the review is kept concealed without assuming the presence of a reliable third party. It can be therefore expected that honest and reliable reviews are actively written. As a result, for example, it can be expected to implement a highly reliable platform that enables each participant to conduct a transaction with security.

The present invention is not limited to the above embodiments that have been specifically disclosed, and various modifications and changes, combinations with known technologies, and the like, can be made without departing from the scope of the claims.

### REFERENCE SIGNS LIST

1 Secure incentive processing system
10 Participant terminal
20 Communication network
101 Input device
102 Display device
103 External I/F
103a Recording medium
104 Communication I/F
105 RAM
106 ROM
107 Auxiliary storage device
108 Processor
109 Bus
201 Secure calculation unit
202 Storage unit

1. A terminal to be used by each of a plurality of participants participating in a predetermined platform, the terminal comprising:
a secure calculation unit that executes predetermined incentive processing according to content of an evaluation x by secure multi-party computation with another terminal connected via a communication network using a fragment [x] of the evaluation x for an evaluation target.

2. The terminal according to claim 1,
wherein the incentive processing includes updating of reputations of the participants, and
the secure calculation unit, when a reputation of an evaluator who has performed the evaluation x is set as rₜ and a reputation of the evaluation target is set as rₛ, updates [rₜ]<←f₁([rₜ], [x]) and [rₛ]←g₁([rₛ], [x]) and the reputation rₜ and the reputation Is by the secure multi-party computation using a function f₁ that outputs an updated fragment [rₜ] according to [a] the fragment [x] and a fragment [rₜ] using the fragment [x] of the evaluation x and the fragment [rₜ] of the reputation rₜ as inputs and a function g₁ that outputs an updated fragment [rₛ] according to the fragment [x] and a fragment [rₛ] using the fragment [x] of the evaluation x and the fragment [rₛ] of the reputation rₛ as inputs.

3. The terminal according to claim 2,
wherein the incentive processing includes disclosure of predetermined information z in a case where a value of the reputation is equal to or greater than a predetermined threshold a, and
the secure calculation unit, when a reputation of the participant is set as r, calculates [z×h(r, a)] by the secure multi-party computation using a function h(r, a) (where the function h(r, a) returns 1 when r is equal to or greater than a and returns 0 when r is less than a) and restores a result of the computation.

4. The terminal according to claim 1,
wherein the incentive processing includes point granting to the participant who has performed the evaluation x, and
the secure calculation unit, when the participant who has performed the evaluation x is set as Pᵢ, a reputation of the participant Pᵢ is set as rᵢ, and a current point of the participant Pᵢ is set as dᵢ, calculates [dᵢ]←f₂([dᵢ], [x], [rᵢ]) by the secure multi-party computation using a function f₂ that outputs a fragment [dᵢ] of the granted point according to a fragment [rᵢ] and [a] the fragment [x] using the fragment [dᵢ] of the point dᵢ, the fragment [rᵢ] of the reputation rᵢ and the fragment [x] of the reputation x as inputs.

5. The terminal according to claim 1,
wherein the incentive processing includes transaction control between participants, and
the secure calculation unit, when participants who conduct a transaction with each other are set as Pₐ and P_{b}, a fragment of a reputation of the participant Pₐ is set as [rₐ], and a fragment of a reputation of the participant P_{b} is set as [r_{b}], calculates C ([rₐ], [r_{b}]) by the secure multi-party computation using a function C that outputs a predetermined index value for controlling the transaction between the participant Pₐ and the participant P_{b} using the fragment [rₐ] and the fragment [r_{b}] as inputs.

6. A method to be executed by a terminal to be used by each of a plurality of participants participating in a predetermined platform, the method comprising:
executing a secure calculation procedure of executing predetermined incentive processing according to content of an evaluation x by secure multi-party computation with another terminal connected via a communication network using a fragment [x] of the evaluation x for an evaluation target.

7. A computer-readable non-transitory recording medium storing computer-executable program instructions that when executed by a processor, by each of a plurality of participants participating in a predetermined platform, cause a terminal to:
execute a secure calculation procedure of executing predetermined incentive processing according to content of an evaluation x by secure multi-party computation with another terminal connected via a communication network using a fragment [x] of the evaluation x for an evaluation target.

8. The terminal according to claim 2,
wherein the incentive processing includes point granting to the participant who has performed the evaluation x, and
the secure calculation unit, when the participant who has performed the evaluation x is set as Pᵢ, a reputation of the participant Pᵢ is set as rᵢ, and a current point of the participant Pᵢ is set as dᵢ, calculates [dᵢ]←f₂([dᵢ], [x], [rᵢ]) by the secure multi-party computation using a function f₂ that outputs a fragment [dᵢ] of the granted point according to a fragment [rᵢ] and the fragment [x] using the fragment [dᵢ] of the point dᵢ, the fragment [rᵢ] of the reputation rᵢ and the fragment [x] of the reputation x as inputs.

9. The terminal according to claim 2,
wherein the incentive processing includes transaction control between participants, and
the secure calculation unit, when participants who conduct a transaction with each other are set as Pₐ and P_{b}, a fragment of a reputation of the participant Pₐ is set as [a], and a fragment of a reputation of the participant P_{b} is set as [r_{b}], calculates C ([rₐ], [b]) by the secure multi-party computation using a function C that outputs a predetermined index value for controlling the transaction between the participant Pₐ and the participant P_{b} using the fragment [rₐ] and the fragment [r_{b}] as inputs.

10. The method according to claim 6,
wherein the incentive processing includes updating of reputations of the participants, and
the secure calculation procedure, when a reputation of an evaluator who has performed the evaluation x is set as rₜ and a reputation of the evaluation target is set as rₛ, updates [rₜ]←f₁([rₜ], [x]) and [rₛ]←g₁([rₛ], [x]) and the reputation rₜ and the reputation rₛ by the secure multi-party computation using a function f₁ that outputs an updated fragment [rₜ] according to the fragment [x] and a fragment [rₜ] using the fragment [x] of the evaluation x and the fragment [rₜ] of the reputation rₜ as inputs and a function g₁ that outputs an updated fragment [rₛ] according to the fragment [x] and a fragment [rₛ] using the fragment [x] of the evaluation x and the fragment [rₛ] of the reputation Is as inputs.

11. The method according to claim 10,
wherein the incentive processing includes disclosure of predetermined information z in a case where a value of the reputation is equal to or greater than a predetermined threshold a, and
the secure calculation procedure, when a reputation of the participant is set as r, calculates [z×h(r, a)] by the secure multi-party computation using a function h(r, a) (where the function h(r, a) returns 1 when r is equal to or greater than a and returns 0 when r is less than a) and restores a result of the computation.

12. The method according to claim 6,
wherein the incentive processing includes point granting to the participant who has performed the evaluation x, and
the secure calculation procedure, when the participant who has performed the evaluation x is set as Pᵢ, a reputation of the participant Pᵢ is set as rᵢ, and a current point of the participant Pᵢ is set as dᵢ, calculates [dᵢ]←f₂([dᵢ], [x], [rᵢ]) by the secure multi-party computation using a function f₂ that outputs a fragment [dᵢ] of the granted point according to a fragment [rᵢ] and the fragment [x] using the fragment [dᵢ] of the point dᵢ, the fragment [rᵢ] of the reputation rᵢ and the fragment [x] of the reputation x as inputs.

13. The method according to claim 10,
wherein the incentive processing includes point granting to the participant who has performed the evaluation x, and
the secure calculation procedure, when the participant who has performed the evaluation x is set as Pᵢ, a reputation of the participant Pᵢ is set as rᵢ, and a current point of the participant Pᵢ is set as dᵢ, calculates [dᵢ]←f₂([dᵢ], [x], [rᵢ]) by the secure multi-party computation using a function f₂ that outputs a fragment [dᵢ] of the granted point according to a fragment [rᵢ] and the fragment [x] using the fragment [dᵢ] of the point dᵢ, the fragment [rᵢ] of the reputation rᵢ and the fragment [x] of the reputation x as inputs.

14. The method according to claim 6,
wherein the incentive processing includes transaction control between participants, and
the secure calculation procedure, when participants who conduct a transaction with each other are set as Pₐ and P_{b}, a fragment of a reputation of the participant Pₐ is set as [rₐ], and a fragment of a reputation of the participant P_{b} is set as [r_{b}], calculates C ([rₐ], [n]) by the secure multi-party computation using a function C that outputs a predetermined index value for controlling the transaction between the participant Pₐ and the participant P_{b} using the fragment [rₐ] and the fragment [r_{b}] as inputs.

15. The method according to claim 10,
wherein the incentive processing includes transaction control between participants, and
the secure calculation procedure, when participants who conduct a transaction with each other are set as Pₐ and P_{b}, a fragment of a reputation of the participant Pₐ is set as [rₐ], and a fragment of a reputation of the participant P_{b} is set as [b], calculates C ([rₐ], [b]) by the secure multi-party computation using a function C that outputs a predetermined index value for controlling the transaction between the participant Pₐ and the participant P_{b} using the fragment [rₐ] and the fragment [r_{b}] as inputs.

16. The computer-readable non-transitory recording medium according to claim 7,
wherein the incentive processing includes updating of reputations of the participants, and
the secure calculation procedure, when a reputation of an evaluator who has performed the evaluation x is set as rₜ and a reputation of the evaluation target is set as rₛ, updates [rₜ]←f₁([rₜ], [x]) and [rₛ]←g₁([rₛ], [x]) and the reputation rₜ and the reputation Is by the secure multi-party computation using a function f₁ that outputs an updated fragment [rₜ] according to the fragment [x] and a fragment [rₜ] using the fragment [x] of the evaluation x and the fragment [rₜ] of the reputation rₜ as inputs and a function g₁ that outputs an updated fragment [rₛ] according to the fragment [x] and a fragment [rₛ] using the fragment [x] of the evaluation x and the fragment [rₛ] of the reputation Is as inputs.

17. The computer-readable non-transitory recording medium according to claim 16,
wherein the incentive processing includes disclosure of predetermined information z in a case where a value of the reputation is equal to or greater than a predetermined threshold a, and
the secure calculation procedure, when a reputation of the participant is set as r, calculates [z×h(r, a)] by the secure multi-party computation using a function h(r, a) (where the function h(r, a) returns 1 when r is equal to or greater than a and returns 0 when r is less than a) and restores a result of the computation.

18. The computer-readable non-transitory recording medium according to claim 7,
wherein the incentive processing includes point granting to the participant who has performed the evaluation x, and
the secure calculation procedure, when the participant who has performed the evaluation x is set as Pᵢ, a reputation of the participant Pᵢ is set as rᵢ, and a current point of the participant Pᵢ is set as dᵢ, calculates [dᵢ]←f₂([dᵢ], [x], [rᵢ]) by the secure multi-party computation using a function f₂ that outputs a fragment [dᵢ] of the granted point according to a fragment [rᵢ] and the fragment [x] using the fragment [dᵢ] of the point dᵢ, the fragment [rᵢ] of the reputation rᵢ and the fragment [x] of the reputation x as inputs.

19. The computer-readable non-transitory recording medium according to claim 7,
wherein the incentive processing includes transaction control between participants, and
the secure calculation procedure, when participants who conduct a transaction with each other are set as Pₐ and P_{b}, a fragment of a reputation of the participant Pₐ is set as [rₐ], and a fragment of a reputation of the participant P_{b} is set as [r_{b}], calculates C ([rₐ], [r_{b}]) by the secure multi-party computation using a function C that outputs a predetermined index value for controlling the transaction between the participant Pₐ and the participant P_{b} using the fragment [rₐ] and the fragment [r_{b}] as inputs.

20. The computer-readable non-transitory recording medium according to claim 16,
wherein the incentive processing includes point granting to the participant who has performed the evaluation x, and
the secure calculation procedure, when the participant who has performed the evaluation x is set as Pᵢ, a reputation of the participant Pᵢ is set as rᵢ, and a current point of the participant Pᵢ is set as dᵢ, calculates [dᵢ]←f₂([dᵢ], [x], [rᵢ]) by the secure multi-party computation using a function f₂ that outputs a fragment [dᵢ] of the granted point according to a fragment [rᵢ] and the fragment [x] using the fragment [dᵢ] of the point dᵢ, the fragment [rᵢ] of the reputation rᵢ and the fragment [x] of the reputation x as inputs.
